(19) United States
(12) Patent Application Publication
(10) Pub. No.: US 2010/0189192 A1
(43) Pub. Date: Jul. 29, 2010

(54) RADIO TRANSMISSION DEVICE, RADIO RECEPTION DEVICE, AND PRECODING METHOD

(75) Inventors: Kenichi Miyoshi, Kanagawa (JP); Shinsuke Takaoka, Kanagawa (JP); Fumiyuki Adachi, Miyagi (JP); Hiromichi Tomeea, Miyagi (JP); Kazuki Takeda, Miyagi (JP)

Correspondence Address: Dickinson Wright PLLC;James E. Ledbetter, Esq., International Square, 1875 Eye Street, N.W., Suite 1200, Washington, DC, 20006, US

(73) Assignee: Panasonic Corporation, Osaka (JP)

(21) Appl. No.: 12/666,274

(22) PCT Filed: Jun. 26, 2008
(86) PCT No.: PCT/JP2008/001676

§ 371 Date: Dec. 22, 2009

(30) Foreign Application Priority Data
Jun. 27, 2007 (JP) 2007-169431

(51) Int. Cl. H04L 27/00; H04L 27/20

(52) U.S. Cl. 375/300; 375/295; 375/316

(57) ABSTRACT

Provided is a radio transmission device which can improve an error ratio characteristic in a radio communication system which performs precoding. There are two types of modulation methods: a first modulation method having a small error ratio improvement width by precoding and a second modulation method having a large error ratio improvement width by precoding. In the radio transmission device (100), a modulation unit (101) modulates transmission data by the second modulation method so as to generate a symbol, a copying unit (102) copies the symbol so as to generate a plurality of symbols, and a precoding unit (105) performs precoding of the symbols.

### TECHNICAL FIELD

The present invention relates to a radio transmitting apparatus, radio receiving apparatus and precoding method.

### BACKGROUND ART

To realize data rates over 100 Mbps for the next generation mobile communication system, various studies are underway for radio transmission schemes that are suitable for high speed packet transmission. Because it is necessary to widen the bandwidth of the frequency band to be used to perform such high speed packet transmission, studies are going on to use the bandwidth around 100 MHz.

If such wideband transmission is performed in mobile communication, it is known that a communication channel becomes a frequency selective channel formed with a plurality of paths of varying delay times. Therefore, with wideband transmission in mobile communication, preceding symbols interfere with subsequent symbols, causing inter-symbol interference (“ISI”) and deteriorating error rate performance. Further, in a frequency selective channel, the channel transfer function fluctuates in the frequency band and therefore the spectrum of a signal that propagates through such a channel is received and is distorted.

The equalization technique provides a technique for canceling the influence of ISI and improving error rate performance. The equalization technique includes frequency domain equalization (“FDE”) used in radio receiving apparatuses. FDE is directed to dividing a received block into quadrature frequency components by performing a fast Fourier transform (“FFT”), multiplying each frequency component by an equalization weight, which is an approximation of the reciprocal of the channel transfer function, and then performing an inverse fast Fourier transform (“IFFT”) of each frequency component into a time domain signal. This FDE can compensate for the spectrum distortion of a received block, so that ISI is reduced and error rate performance is improved.

Further, recently, studies are going on to combine Tomlinson-Harashima Precoding (hereinafter, “THP”) with FDE as the transmission equalization technique of the precoding technique (for example, see Non-Patent Document 1). That is, studies are going on to perform THP of transmission blocks in a radio transmitting apparatus and perform FDE of received blocks in a radio receiving apparatus. THP refers to processing of sequentially subtracting interference components from transmission blocks based on channel information. This THP makes it possible to cancel in advance the interference components which are added to transmission blocks, reduce ISI and improve error rate performance. Meanwhile, in case where channel information is completely learned, transmission to suppress ISI completely is possible. For example, even in case where frequency selective fading deteriorates the received level of frequency components significantly, and interference components are not removed because the frequency components are not completely equalized by performing FDE, it is possible to prevent deterioration of error rate performance by combining THP with FDE to remove interference components in advance.

Non-Patent Document 1: “Single-Carrier Transmission with Frequency-Domain Equalization Using Tomlinson-Harashima Precoding,” K. Takeda, H. Tomeba, F. Adachi, IEICE Technical Report, RCS2006-41, pp. 37-42, 2006-6

### DISCLOSURE OF INVENTION

### Problems to be Solved by the Invention

Here, according to computer simulation performed by the inventors of the present invention, upon QPSK modulation error rate performance 11 in case where only FDE is used and error rate performance 12 in case where THP is combined with FDE, are as shown in FIG. 1. According to the result of this computer simulation, error rate performance 11 and error rate performance 12 have the same level of Eb/No required to satisfy the error rate 10⁻³. That is, the simulation result shown in FIG. 1 shows that error rate performance does not improve even if THP is combined with FDE upon QPSK modulation. Therefore, upon QPSK modulation, processing of performing THP becomes wasteful.

It is therefore an object of the present invention to provide a radio transmitting apparatus, radio receiving apparatus and precoding method for improving error rate performance in mobile communication where precoding is combined with FDE.

### Means for Solving the Problem

The radio transmitting apparatus according to the present invention employs a configuration which includes: a modulating section that employs a first modulation scheme in which a level of error rate performance improvement by precoding is low and a second modulation scheme in which the level of the error rate performance improvement by the precoding is high, and that modulates transmission data according to the second modulation scheme to generate a symbol; a repetition section that repeats the symbol to acquire a plurality of symbols; a precoding section that performs the precoding with respect to the plurality of symbols; and a transmitting section that transmits the plurality of symbols after the precoding.

### ADVANTAGEOUS EFFECTS OF INVENTION

The present invention makes it possible to improve error rate performance, in mobile communication where precoding is combined with FDE.

### BRIEF DESCRIPTION OF DRAWINGS

FIG. 1 is a comparison example of error rate performance upon QPSK modulation;

FIG. 2 is a comparison example of error rate performance upon 16 QAM modulation;

FIG. 3 is a block diagram showing a configuration of a radio transmitting apparatus according to Embodiment 1 of the present invention;

FIG. 4 shows an MCS table for a radio receiving apparatus according to Embodiment 1 of the present invention that performs FDE;

FIG. 5 shows an MCS table for a radio receiving apparatus according to Embodiment 1 of the present invention that does not perform FDE;

FIG. 6 is a block diagram showing a configuration of a radio receiving apparatus according to Embodiment 1 of the present invention;

FIG. 7 shows symbol arrangement according to Embodiment 1 of the present invention (arrangement example 1);

FIG. 8 shows symbol arrangement according to Embodiment 1 of the present invention (arrangement example 2);

FIG. 9 is a block diagram showing a configuration of a radio transmitting apparatus according to Embodiment 2 of the present invention; and

FIG. 10 shows an MCS table according to Embodiment 2 of the present invention.

### BEST MODE FOR CARRYING OUT THE INVENTION

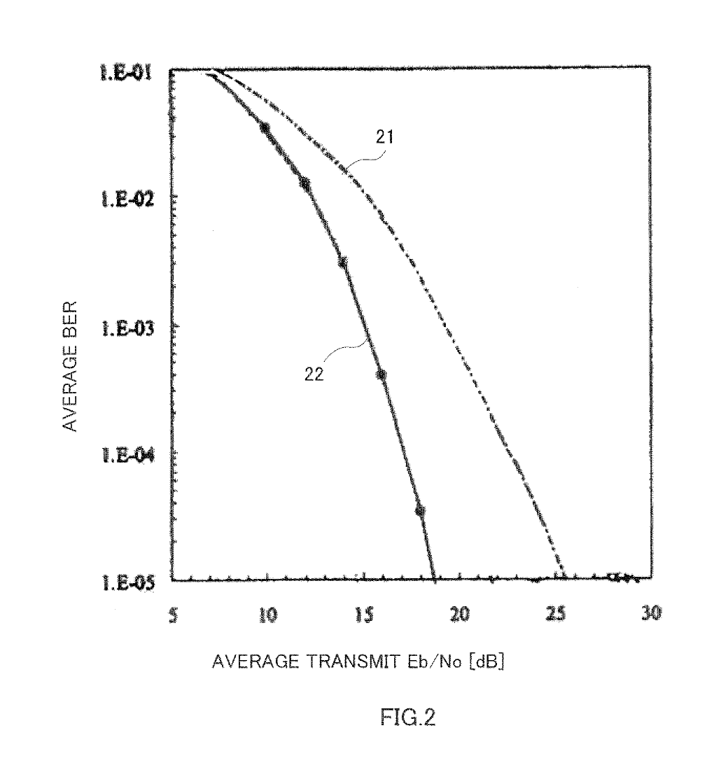

According to computer simulation performed by the inventors of the present invention, upon 16 QAM modulation error rate performance 21 in case where only FDE is used and error rate performance 22 in case where THP is combined with FDE, are as shown in FIG. 2. According to the result of this computer simulation, Eb/No of error rate performance 22 required to satisfy the error rate 10⁻³ are improved about 4 dB compared to error rate performance 21. Signals modulated according to a modulation scheme using phase information and amplitude information such as QAM are significantly distorted due to the influence of interference received in a channel. Therefore, interference cannot be equalized by FDE alone and error rate performance deteriorates due to ISI. However, by combining THP with FDE, it is possible to prevent deterioration of error rate performance due to ISI.

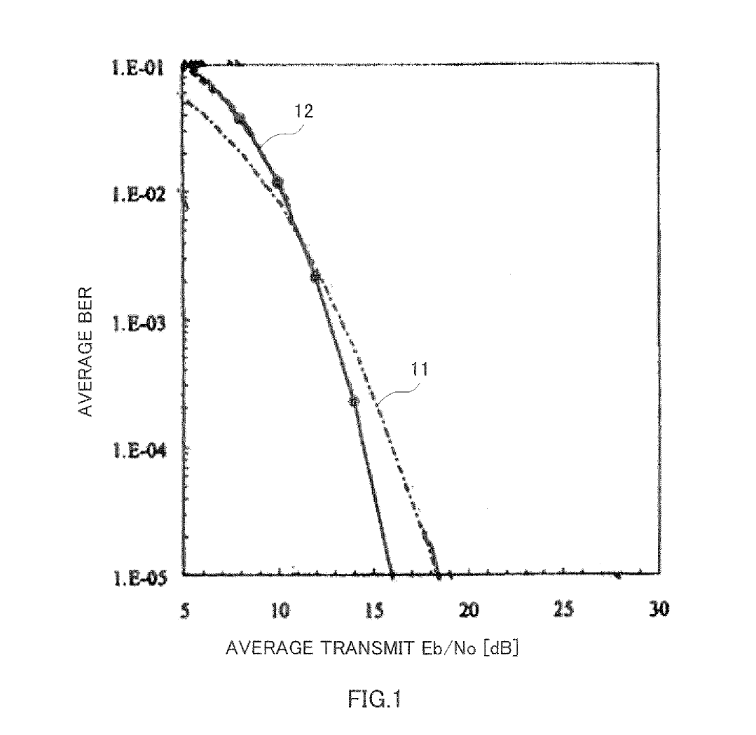

Accordingly, in case where THP is combined with FDE, while the level of error rate performance improvement by THP is low with the first modulation scheme (for example, QPSK in FIG. 1) using only phase information, the level of error rate performance improvement by THP is high with the second modulation scheme (for example, 16 QAM in FIG. 2) using phase information and amplitude information.

Hereinafter, embodiments of the present invention will be explained in detail with reference to the accompanying drawings.

### Embodiment 1

With the present embodiment, in case where THP is combined with FDE, transmission data is modulated according to the second modulation scheme of the first modulation scheme and second modulation scheme.

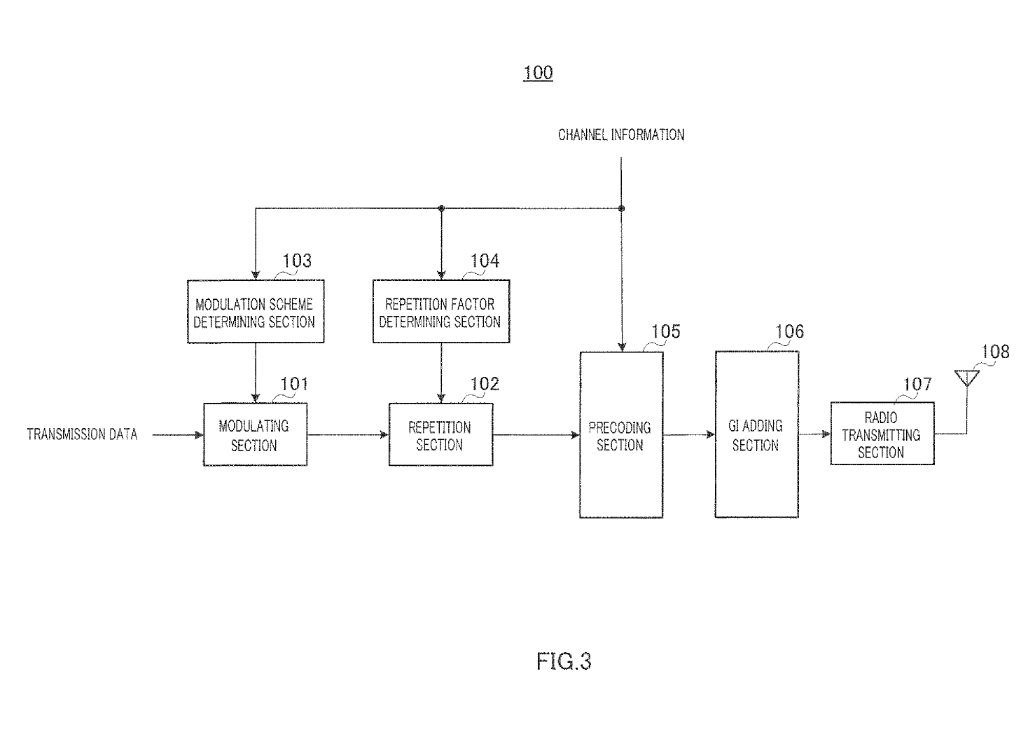

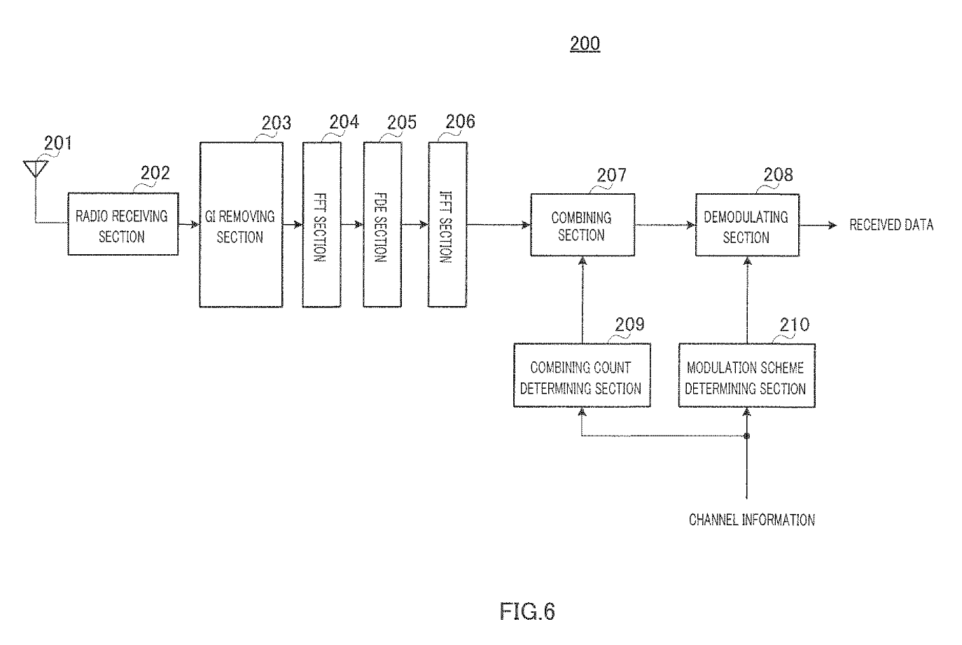

With the present embodiment, a radio transmitting apparatus transmits single carrier signals subjected to THP, to a radio receiving apparatus, and the radio receiving apparatus performs FDE of the single carrier signals. Further, there are radio receiving apparatuses according to the present embodiment that perform FDE, and, in addition, radio receiving apparatuses that do not perform FDE. Hereinafter, the configurations of the radio transmitting apparatus and radio receiving apparatus according to the present embodiment will be explained. FIG. 3 shows the configuration of radio transmitting apparatus 100 according to the present embodiment, and FIG. 6 shows the configuration of radio receiving apparatus 200 according to the present embodiment that performs FDE.

In radio transmitting apparatus 100 shown in FIG. 3, modulating section 101 modulates transmission data by a modulation scheme notified from modulation scheme determining section 103, to generate a symbol sequence formed with a plurality of symbols. Then, modulating section 101 outputs the symbol sequence to repetition section 102.

Repetition section 102 repeats the symbol sequence received as input from modulating section 101 (i.e. repetition), to acquire a plurality of symbol sequences. Here, the number of symbol sequences acquired in repetition section 102 is determined based on the repetition factor received as input from repetition factor determining section 104. By this means, a block in which a plurality of identical symbol sequences are arranged consecutively in the time domain is formed. Then, repetition section 102 outputs the block of a time domain signal, to precoding section 105.

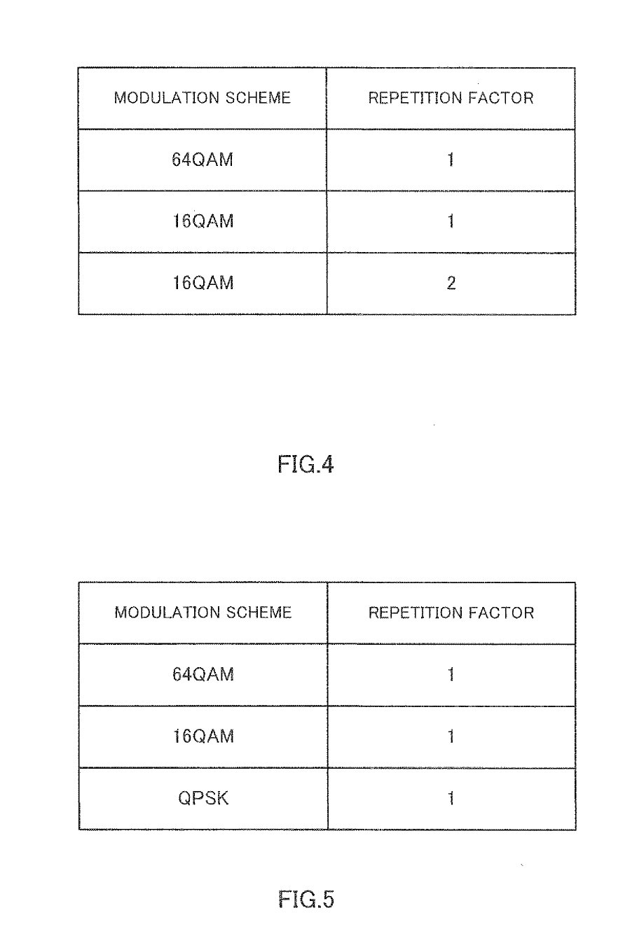

From a receiving section (not shown), modulation scheme determining section 103 receives as input channel information which is fed back from radio receiving apparatus 200 and which shows the transmission characteristics of the channel. Then, modulation scheme determining section 103 determines the modulation scheme for transmission data transmitted to a radio receiving apparatus that performs FDE, with reference to the table shown in FIG. 4, and determines transmission data transmitted to a radio receiving apparatus that does not perform FDE, with reference to the table shown in FIG. 5. Modulation scheme determining section 103 determines one of the modulation schemes included in the table shown in FIG. 4 or FIG. 5, based on channel quality determined from channel information. Then, modulation scheme determining section 103 notifies the determined modulation scheme to modulating section 101.

Here, the table shown in FIG. 4 is configured with a plurality of second modulation schemes, and the table shown in FIG. 5 is configured with the first modulation scheme and second modulation schemes. That is, while transmission data transmitted to a radio receiving apparatus that performs FDE is modulated according to one of a plurality of second modulation schemes shown in FIG. 4, transmission data transmitted to a radio receiving apparatus that does not perform FDE is modulated according to one of the first modulation scheme and the second modulation schemes shown in FIG. 5. Further, each modulation scheme in the table shown in FIG. 4 and each modulation scheme shown in FIG. 5 are associated with the same channel quality. That is, 64 QAM in the upper row of the table shown in FIG. 4 and 64 QAM in the upper row of the table shown in FIG. 5 are associated with the same channel quality, 16 QAM in the middle row of the table shown in FIG. 4 and 16 QAM in the middle row of the table shown in FIG. 5 are associated with the same channel quality, and 16 QAM in the lower row of the table shown in FIG. 4 and QPSK in the lower row of the table shown in FIG. 5 are associated with the same channel quality.

Repetition factor determining section 104 determines the repetition factor (“RF”) for a symbol sequence with reference to the table shown in FIG. 4 in case where a radio receiving apparatus as a transmission destination of transmission data performs FDE, and determines the repetition factor with reference to the table shown in FIG. 5 in case where a radio receiving apparatus as the transmission destination of transmission data does not perform FDE. Repetition factor determining section 104 determines the repetition factor based on channel quality determined from channel information received as input from the receiving section (not show).

Here, as shown in FIG. 4 and FIG. 5, with the first modulation scheme and the second modulation scheme that are associated with the same channel quality and that are used for a radio receiving apparatus that does not perform FDE and a radio receiving apparatus that performs FDE, respectively, only symbol sequences generated using the second modulation scheme are repeated. To be more specific, with 16 QAM and QPSK that are associated with the same channel quality and that are provided in the lower row of the table shown in FIG. 4 and in the lower row of the table shown in FIG. 5, respectively, only symbol sequences generated using 16 QAM are repeated. Further, the repetition factor is determined based on the difference between the M-ary modulation value of the first modulation scheme and the M-ary modulation value of the second modulation scheme. To be more specific, the repetition factor is determined based on log₂n/log₂m. Here, m is the M-ary modulation value of the first modulation scheme and n is the M-ary modulation value of the second modulation scheme. Consequently, as shown in FIG. 4 and FIG. 5, in case where the first modulation scheme is QPSK (m=4) and the second modulation scheme is 16 QAM (n=16), the repetition factor is two. Then, repetition factor determining section 104 outputs the determined repetition factor to repetition section 102.

Using THP, precoding section 105 precodes the block received as input from repetition section 102. THP for a block formed with N_{c} symbols is implemented by a feedback filter of maximum N_{c} taps and a Modulo operation circuit. Further, the number of symbols N_{c} forming one block is the same as the number of symbols subjected to FDE in radio receiving apparatus 200. To be more specific, in THP, when an input block s=[s(N_{c}−1) . . . s(0)]^{T} of a block length N_{c} formed with symbols s(t)(t=0 to N_{c}−1) is received as input, the output block x=[x(N_{c}−1) . . . x(0)]^{T} is determined by following equation 1.

(Equation 1)

x=s−Fx+2Mzᵢ [1]

Here, the matrix F is the filter coefficient matrix at the time each symbol is received as input, and can be represented by following equation 2.

[2]

$$F = [ \begin{matrix}0 & {f}_{0 , 1} & … & {f}_{0 , {N}_{C} - 1} \\ & ⋱ & ⋱ & ⋮ \\ & & ⋱ & {f}_{{N}_{C} - 2 , {N}_{C} - 1} \\ 0 & & & 0\end{matrix} ] \qquad ( Equation 2 )$$

f_{t,t+τ} refers to the τ-th feedback coefficient at the time the symbol s(t) is received as input. Feedback coefficients use the impulse response of a channel other than desired wave components in channel information received as input in precoding section 105. Further, zₜ=[zₜ(N_{c}−1) . . . zₜ(0)]^{T} is an equivalent representation of a Modulo operation. The Modulo operation transforms the real part and the imaginary part of a signal acquired in loop processing of a feedback filter, within the range of [−M, M] to stabilize outputs of THP. Further, in equation 1, the symbol s(t) satisfies −M≦{Re[s(t)], Im[s(t)]}<M. Then, precoding section 105 outputs the block subjected to THP, to GI (Guard Interval) adding section 106.

GI adding section 106 adds the rear portion of the block, as a GI, to the head of the block received as input from precoding section 105. Meanwhile, a signal formed with a block and a GI added to the head of the block, may be referred to as a “slot.”

Radio transmitting section 107 performs radio transmission processing such as D/A conversion, amplification and up-conversion with respect to the block to which a GI is added, and transmits the signal from antenna 108 to radio receiving section 200 (FIG. 6). That is, radio transmitting section 107 transmits a single carrier signal to which a GI is added, to radio receiving apparatus 200.

Radio receiving section 202 of radio receiving apparatus 200 shown in FIG. 6 receives the single carrier signal transmitted from radio transmitting apparatus 100, that is, a time domain signal formed with a plurality of the identical symbol sequences modulated according to the second modulation scheme in the first modulation scheme and the second modulation scheme, through antenna 201, and performs radio receiving processing such as down-conversion and A/D conversion with respect to this single carrier signal.

GI removing section 203 removes the GI from the single carrier signal after radio receiving processing, and outputs the signal from which the GI has been removed, to FFT section 204.

FFT section 204 performs an FFT of a signal received as input from GI removing section 203, on a per block basis, to transform each time domain signal block, into a frequency domain signal. To be more specific, FFT section 204 performs an N_{c}-point FFT of a block of a block length N_{c} transmitted from radio transmitting apparatus 100 (FIG. 1) to divide the block of the block length N_{c} into N_{c} frequency components R(k)(k=0 to N_{c}−1). Then, FFT section 204 outputs the frequency components R(k)(k=0 to N_{c}−1), to FDE section 205.

FDE section 205 performs FDE of the frequency domain signal received as input from FFT section 204, that is, the frequency components R(k)(k=0 to N_{c}−1). To be more specific, FDE section 205 multiplies each frequency component by an equalization weight w(k)(k=0 to N_{c}−1). That is, FDE is equivalent to linear filtering processing that uses w(k)(k=0 to N_{c}−1) as the transfer function. Then, FDE section 205 outputs the frequency components subjected to FDE, to IFFT section 206.

IFFT section 206 performs an IFFT of the frequency components received as input from FDE section 205, on a per block basis, to transform the frequency components into a time domain signal block. To be more specific, IFFT section 206 performs an N_{c}-point IFFT of N_{c} frequency components, to transform the N_{c} frequency components into a time domain signal block formed with N_{c} symbols. IFFT section 206 outputs the block subjected to the IFFT, to combining section 207.

Combining section 207 separates the block received as input from IFFT section 206 into a plurality of symbol sequences based on the number of times of combining received as input from combining count determining section 209. Then, combining section 207 generates a combined symbol sequence by combining a plurality of symbol sequences. Further, combining section 207 outputs the combined symbol sequence to demodulating section 208.

Demodulating section 208 demodulates the combined symbol sequence received as input from combining section 207, according to the modulation scheme notified from modulation scheme determining section 210 to acquire combined data. Received data is obtained as above explanation.

Combining count determining section 209 determines the number of times of combining the symbol sequence with reference to the table shown in FIG. 4. Combining count determining section 209 determines the same number of times of combining as the repetition factor shown in FIG. 4, based on channel quality determined from channel information received as input from the measuring section (not shown). Then, combining count determining section 209 outputs the determined number of times of combining to combining section 207.

Modulation scheme determining section 210 determines the modulation scheme for demodulating the combined symbol sequence with reference to the table shown in FIG. 4. Modulation scheme determining section 210 determines one of the modulation schemes shown in FIG. 4, based on channel quality determined from channel information received as input from the measuring section (not shown). That is, modulation scheme determining section 210 determines the modulation scheme for demodulating the combined symbol sequence, from a plurality of second modulation schemes. Then, modulation scheme determining section 210 notifies the determined modulation scheme to demodulating section 208. Further, a radio receiving apparatus (not shown) that does not perform FDE determines the modulation scheme with reference to the MCS table shown in FIG. 5.

Next, the operation of radio transmitting apparatus 100 having the above configuration will be explained in detail.

The details will be explained below. Here, assume that transmission data has 256 bits and one block has 128 symbols. Further, in the upper rows and middle rows of the tables shown in FIG. 4 and FIG. 5, the modulation schemes associated with the same channel qualities and the repetition factors for symbol sequences are the same. Therefore, the lower rows of the tables of FIG. 4 and FIG. 5 will be explained where the modulation schemes associated with the same channel quality and the repetition factors for symbol sequences are different. That is, with transmission data transmitted to radio receiving apparatus 200 that performs FDE, the modulation scheme is 16 QAM and the repetition factor is two as shown in FIG. 4. Further, with transmission data transmitted to a radio receiving apparatus that does not perform FDE, the modulation scheme is QPSK and the repetition factor for symbol sequences is one as shown in FIG. 5.

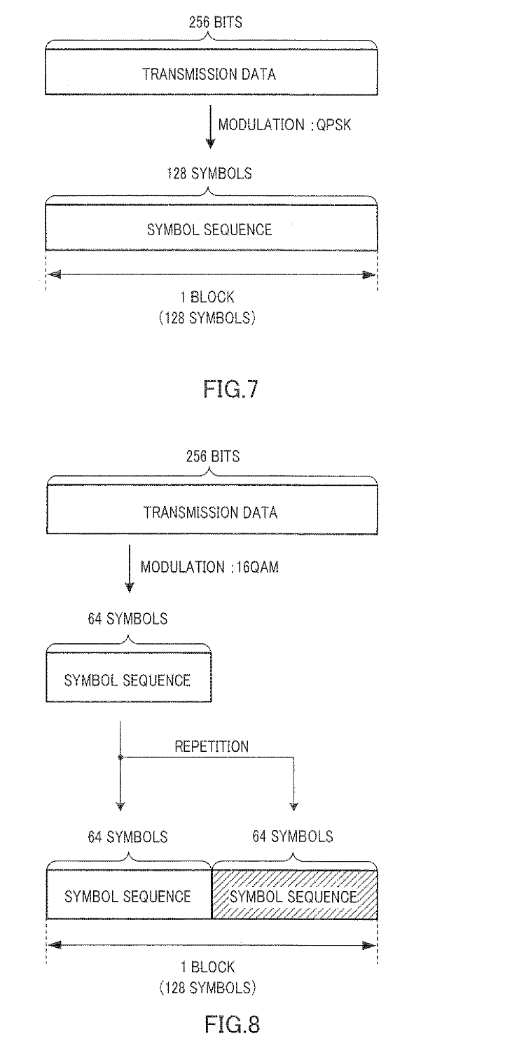

Modulating section 101 modulates transmission data of 256 bits transmitted to a radio receiving apparatus (not shown) that does not perform FDE, by QPSK to generate a symbol sequence of 128 symbols. Then, the symbol sequence repetition factor is one as shown in FIG. 7 and therefore repetition section 102 forms a block of 128 symbols using the symbol sequence as is without performing repetition.

By contrast with this, modulating section 101 modulates transmission data of 256 bits transmitted to radio receiving apparatus 200 (FIG. 6) that performs FDE, by 16 QAM, to generate a symbol sequence of 64 symbols. Further, the symbol sequence repetition factor is two, and therefore repetition section 102 repeats the symbol sequence of 64 symbols to acquire two symbol sequences. By this means, as shown in FIG. 8, repetition section 102 forms a block of 128 symbols formed with two symbol sequences that are consecutive in the time domain.

In this way, with QPSK and 16 QAM associated with the same channel quality, even if the modulation scheme for a radio receiving apparatus that does not perform FDE is QPSK, transmission data transmitted to radio receiving apparatus 200 that performs FDE is modulated by 16 QAM, so that it is possible to improve error rate performance as shown in FIG. 2. Consequently, as shown in FIG. 4, transmission data transmitted to radio receiving apparatus 200 that performs FDE is modulated according to the second modulation scheme of any channel quality at all times, so that it is possible to improve error rate performance reliably.

Further, with QPSK and 16 QAM associated with the same channel quality, while transmission data of 256 bits is transmitted with QPSK using 128 symbols, transmission data can be transmitted with 16 QAM using 64 symbols, which is half of 128 symbols. That is, by modulating 256 bits by 16 QAM, a margin of 64 symbols is produced in the time domain. Then, as shown in FIG. 8, the identical symbol sequence of 64 symbols that is repeated is transmitted using a margin of 64 symbols in the time domain, so that, even if the modulation scheme is 16 QAM, it is possible to transmit data of 256 bits of the same data length using 128 symbols of the same number of symbols as in the case where the modulation scheme is QPSK, and acquire a time diversity effect thanks to repetition.

In this way, according to the present embodiment, with the first modulation scheme and the second modulation scheme associated with the same channel quality, when the modulation scheme for a radio receiving apparatus that does not perform FDE is the first modulation scheme, a radio transmitting apparatus that performs THP modulates transmission data transmitted to a radio receiving apparatus that performs FDE, according to the second modulation scheme. That is, for a radio receiving apparatus that performs FDE, modulation is performed using only a second modulation scheme that shows the high level of error rate performance improvement by THP. Consequently, it is possible to improve error rate performance reliably in a radio communication system that performs precoding.

Further, according to the present embodiment, the radio transmitting apparatus can adaptively determine a modulation scheme that provides optimal error rate performance, depending on whether or not a radio receiving apparatus as a transmission destination of transmission data performs FDE. Consequently, even when there are radio receiving apparatuses that perform FDE and radio receiving apparatuses that do not perform FDE, it is possible to improve error rate performance reliably.

Furthermore, according to the present embodiment, in the first modulation scheme and the second modulation scheme that are associated with the same channel quality and that are used for a radio receiving apparatus that does not perform FDE and a radio receiving apparatus that performs FDE, respectively, symbol sequences generated using the second modulation scheme are repeated. Therefore, according to the present embodiment, a time diversity effect can be acquired by repeating symbol sequences, so that it is possible to further improve error rate performance.

Further, although a radio receiving apparatus that performs FDE and a radio receiving apparatus that does not perform FDE has been explained in a fixed fashion with the present embodiment, whether or not a radio receiving apparatus performs FDE may be switched adaptively. At this time, by reporting information indicating whether or not a radio receiving apparatus performs FDE, from this radio receiving apparatus to a radio transmitting apparatus, the radio transmitting apparatus decides a type of the radio receiving apparatus.

Further, although, with the present embodiment, the second modulation scheme and the first modulation scheme associated with the same channel quality are 16 QAM and QPSK, respectively, the first modulation scheme is not limited to QPSK and, further, the second modulation scheme is not limited to 16 QAM. For example, the second modulation scheme may be 64 QAM and 256 QAM. In case where the second modulation scheme is 64 QAM, that is, the M-ary modulation number is 64, it is possible to transmit three times as many as bits using the same number of symbols as the first modulation scheme of QPSK (where the M-ary modulation number is four). Therefore, in case where the second modulation scheme and the first modulation scheme associated with the same channel quality are 64 QAM and QPSK, respectively, a symbol sequence is repeated to three sequences. Further, in case where the second modulation scheme is 256 QAM, that is, the M-ary modulation number is 256, it is possible to transmit four times as many as bits using the same number of bits as the first modulation scheme of QPSK. Therefore, in case where the second modulation scheme and the first modulation scheme associated with the same channel quality are 256 QAM and QPSK, respectively, a symbol sequence is repeated to four sequences.

Further, a case has been explained with the present embodiment where the number of a plurality of symbol sequences acquired in repetition section 102, that is, the repetition factor in the table shown in FIG. 4 is determined based on the difference between the M-ary modulation values of the first modulation scheme and the second modulation scheme associated with the same channel quality. However, the M-ary modulation value is correlated with the number of bits in one symbol, so that the repetition factor may be determined based on the difference between the number of bits M and the number of bits N in one symbol in the first modulation scheme and the second modulation scheme associated with the same channel quality. To be more specific, the number of symbol sequences is determined based on N/M.

Further, although a case has been explained with the present embodiment where a plurality of symbol sequences are acquired by repeating a symbol sequence, a plurality of symbols may be acquired by modulating a plurality of items of transmission data acquired by repeating transmission data.

### Embodiment 2

With the present embodiment, transmission data is modulated by one of the first modulation scheme and the second modulation scheme, and THP is applied to symbol sequences generated using the second modulation scheme and is not applied to symbol sequences generated using the first modulation scheme.

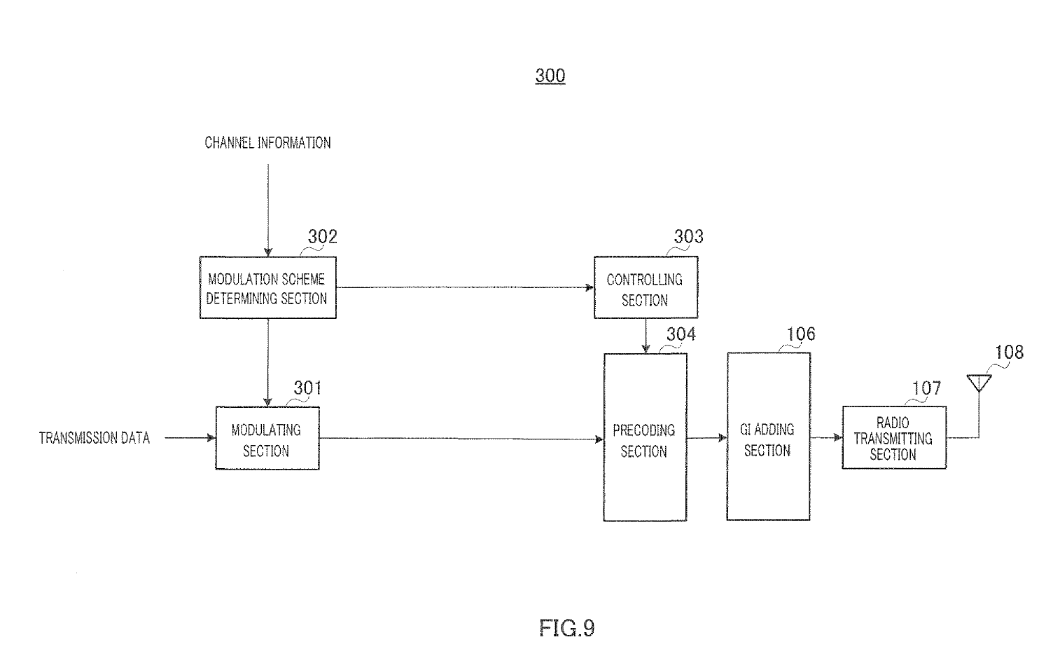

FIG. 9 is a block diagram showing the configuration of radio transmitting apparatus 300 according to the present embodiment. Note that the same components as in the configuration of radio transmitting apparatus 100 (FIG. 3) of Embodiment 1 will be assigned the same reference numerals and explanation thereof will be omitted.

In radio transmitting apparatus 300 shown in FIG. 9, modulating section 301 modulates transmission data according to the modulation scheme notified from modulation scheme determining section 302, to generate a symbol sequence formed with a plurality of symbols. By this means, a block in which a symbol sequence is arranged in the time domain is formed. Then, modulating section 301 outputs the time domain signal block, to precoding section 304.

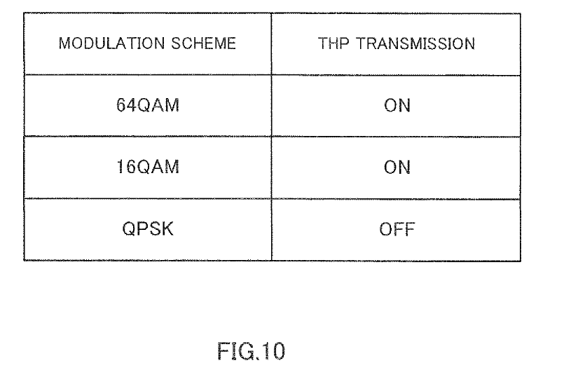

Modulation scheme determining section 302 determines the modulation scheme for transmission data with reference to the table shown in FIG. 10. Modulation scheme determining section 302 determines one of the modulation schemes included in the table shown in FIG. 10, based on channel quality determined from channel information received as input from the receiving section (not shown). Here, the table shown in FIG. 10 is configured with the first modulation scheme and second modulation schemes. Further, modulation scheme determining section 302 notifies the determined modulation scheme to modulating section 301 and controlling section 303.

Controlling section 303 controls precoding section 304 as to whether or not to perform THP, based on the modulation scheme notified from modulation scheme determining section 302. To be more specific, as shown in FIG. 10, controlling section 303 controls precoding section 304 to apply THP to symbol sequences generated using 16 QAM or 64 QAM of the second modulation scheme, and controls precoding section 304 not to apply THP to symbol sequences generated using QPSK of the first modulation scheme. Controlling section 303 outputs a control signal indicating whether or not THP processing is performed, to precoding section 304.

Precoding section 304 precodes the block received as input from modulating section 301 using THP, based on the control signal received as input from controlling section 303. To be more specific, in case where the control signal received as input from controlling section 303 indicates that THP will be performed, precoding section 304 precodes the block using THP and outputs the block after THP, to GI adding section 106. By contrast with this, in case where the control signal received as input from controlling section 303 indicates that THP will not be performed, precoding section 304 does not precode the block using THP and outputs the block as is to GI adding section 106.

As described above, in case where THP is combined with FDE, THP provides an advantage of error rate performance improvement only with the second modulation scheme that uses phase information and amplitude information. In other words, as shown in FIG. 1, with the first modulation scheme that uses only phase information, it is not possible to realize error rate performance improvement even if THP is combined with FDE. However, as shown in FIG. 1, it is possible to provide good error rate performance using only FDE with the first modulation scheme. Consequently, as shown in FIG. 10, by not applying THP to symbol sequences generated using QPSK, it is possible to reduce processing of performing THP while maintaining error rate performance.

In this way, according to the present embodiment, the radio transmitting apparatus does not apply THP to generated symbol sequences in case where transmission data is modulated according to the first modulation scheme using only phase information. By this means, it is possible to maintain good error rate performance in case where the first modulation scheme is used, and improve error rate performance in case where the second modulation scheme is used. Consequently, it is possible to improve error rate performance in case where modulation is performed according to one of the first modulation scheme and the second modulation scheme in a radio communication system that performs precoding.

Further, according to the present embodiment, it is possible to reduce processing of performing THP in case where the first modulation scheme is used, so that it is possible to improve processing efficiency in the radio transmitting apparatus.

Embodiments of the present invention have been explained above.

Further, a radio transmitting apparatus and radio receiving apparatus according to the present invention are suitable for use in radio communication mobile station apparatuses or radio communication base station apparatuses used in, for example, a mobile communication system. By mounting the radio transmitting apparatus and radio receiving apparatus according to the present invention in a radio communication mobile station apparatus or radio communication base station apparatus, it is possible to provide a radio communication mobile station apparatus and radio communication base station apparatus that provide the same operation and effect described above.

Further, with the above embodiments, precoding is performed using THP. However, the present invention is not limited to THP and is applicable to all precoding methods having characteristics that error rate performance is not improved according to modulation schemes using only phase information and error rate performance is improved according to the modulation schemes using phase information and amplitude information.

Further, although, with the above embodiments, QPSK is employed for the first modulation scheme using only phase information, and 16 QAM or 64 QAM is employed for the second modulation scheme using phase information and amplitude information, the first modulation scheme is not limited to QPSK and the second modulation scheme is not limited to 16 QAM or 64 QAM.

Also, although cases have been described with the above embodiment as examples where the present invention is configured by hardware, the present invention can also be realized by software.

Each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2007-169431, filed on Jun. 27, 2007, including the specification, drawings and abstract, is incorporated herein by reference in its entirety.

### INDUSTRIAL APPLICABILITY

The present invention is applicable to, for example, a mobile communication system.

1. A radio transmitting apparatus comprising:
a modulating section that employs a first modulation scheme in which a level of error rate performance improvement by precoding is low and a second modulation scheme in which the level of the error rate performance improvement by the precoding is high, and that modulates transmission data according to the second modulation scheme to generate a symbol;
a repetition section that repeats the symbol to acquire a plurality of symbols;
a precoding section that performs the precoding with respect to the plurality of symbols; and
a transmitting section that transmits the plurality of precoded symbols.

2. The radio transmitting apparatus according to claim wherein:
the first modulation scheme uses only phase information; and
the second modulation scheme uses the phase information and amplitude information.

3. The radio transmitting apparatus according to claim 1, wherein the modulating section modulates transmission data transmitted to a first radio receiving apparatus that performs frequency domain equalization, according to one of a plurality of second modulation schemes, and modulates transmission data transmitted to a second radio receiving apparatus that does not perform frequency domain equalization, according to one of the first modulation scheme and the second modulation schemes.

4. The radio transmitting apparatus according to claim 3, wherein, in the second modulation scheme and the first modulation scheme that are associated with same channel quality and that are used for the first radio receiving apparatus and for the second radio receiving apparatus, respectively, the repetition section repeats only a symbol generated using the second modulation scheme.

5. The radio transmitting apparatus according to claim 1, wherein the repetition section acquires the plurality of log₂n/log₂m symbols where m is an M-ary modulation value of the first modulation scheme and n is an M-ary modulation value of the second modulation scheme.

6. The radio transmitting apparatus according to claim 1, wherein the precoding section performs the precoding using a Tomlinson-Harashima precoding method.

7. A radio receiving apparatus comprising:
a receiving section that receives a plurality of identical symbols of transmission data modulated according to a second modulation scheme in a first modulation scheme in which a level of error rate performance improvement by precoding is low and the second modulation scheme in which the level of the error rate performance improvement by the precoding is high;
an equalizing section that performs frequency domain equalization with respect to the plurality of received symbols;
a combining section that combines the plurality of equalized symbols to generate a combined symbol; and
a demodulating section that demodulates the combined symbol according to the second modulation scheme to generate combined data.

8. The radio transmitting apparatus according to claim 1, wherein the radio transmitting apparatus comprises one of a radio communication base station apparatus and a radio communication mobile station apparatus.

9. The radio receiving apparatus according to claim 7, wherein the radio receiving apparatus comprises one of a radio communication base station apparatus and a radio communication mobile station apparatus.

10. A precoding method comprising, in a first modulation scheme in which a level of error rate performance improvement by precoding is low and a second modulation scheme in which the level of the error rate performance improvement by the precoding is high, precoding a plurality of identical symbols of transmission data modulated according to the second modulation scheme.
